(19) United States
(12) Patent Application Publication
(10) Pub. No.: US 2022/0108343 A1
(43) Pub. Date: Apr. 7, 2022

(54) LOYALTY SYSTEM, LOYALTY TRACKING SYSTEM, MERCHANT MULTI-USE LOYALTY SYSTEM, MERCHANT OFFERING PLATFORM, LOYALTY SHARING SYSTEM, LOYALTY PLATFORM, SHARING NETWORK PLATFORM, COMMERCIAL INCETIVISING SYSTEM, AND METHODS OF USE

(71) Applicant: Andrew David Frank Knott, Hove (GB)

(72) Inventor: Andrew David Frank Knott, Hove (GB)

(21) Appl. No.: 17/489,955

(22) Filed: Sep. 30, 2021

Related U.S. Application Data
(60) Provisional application No. 63/086,277, filed on Oct. 1, 2020.

(51) Int. Cl. G06Q 30/02; G06Q 20/40

(52) U.S. Cl. CPC G06Q 30/0229; G06Q 30/0208; G06Q 20/40; G06Q 30/0227; G06Q 30/0233

(57) ABSTRACT

A loyalty system, loyalty tracking system, merchant multi-use loyalty system, merchant offering platform, loyalty sharing system, loyalty platform, sharing network platform, commercial incentivising system, and methods of use are presented. The present loyalty system provides for a system with many features including the ability to share loyalties earned with other users. Furthermore, the system provides for maintaining access to loyalties even if shared. The loyalty system provides for an incentive program. Furthermore, the present disclosure provides for various covid features enabling operation of restaurants and other merchants, and the like.

### CROSS-REFERENCE TO RELATED APPLICATIONS

The present application claims priority to the U.S. Provisional Patent Application No. 63/086,277 which was filed on Oct. 1, 2020, which is hereby incorporated by reference herein in its entirety, including any figures, tables, or drawings.

### FIELD OF THE DISCLOSURE

This disclosure relates to a loyalty system, loyalty tracking system, merchant multi-use loyalty system, merchant offering platform, loyalty sharing system, loyalty platform, sharing network platform, commercial incentivising system, and methods of use. More specifically, and without limitation, this disclosure relates to a platform currency system which provides for a percentage discount off future items and a system associated therewith. More specifically, and without limitation, this disclosure relates to a multi-use loyalty system. More specifically, and without limitation, this disclosure provides a system and method of use for accumulation of loyalty rewards, redeeming, and sharing. More specifically, and without limitation, this disclosure relates to providing merchants a means of creating offers and the like. Furthermore, and without limitation, this disclosure relates to a sharing network for offers, ratings, friendship, networking, discount sharing, incentivising, referrals, sharing offers, and the like, and related methods of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright Foosh. Copyright Andrew Knott All rights reserved.

### BACKGROUND OF THE DISCLOSURE:

Loyalty and/or customer rewards systems are fairly well known in the art. A loyalty program is generally speaking a marketing strategy put into place to engage customers and/or encourage customers to engage with businesses. In this way, loyalty programs encourage customers to purchase from a particular shop or merchant, which the customer regularly associates with.

Various programs and rewards systems exist in the art today. Most of which cover a type of commerce, having varying features and schemes. Some existing loyalty programs exist in banking, entertainment, hospitality, retailing, and travel. In this way, the varying programs can be used to entice customers to more regularly engage in entertainment services, retail purchases, and the like.

A customer rewards program typically involves a business and a customer. The business sets up a reward system based on a set of rules and then issues a loyalty card, or rewards card, or points card, or advantage card, or club card, or VIP card, or punch card, or Gold member card, or some other name of a card that indicates to the customer that they are valued. In this way, a customer will provide their card at the time of each purchase and/or each transaction made with the business. The business will punch the card, stamp the card, scan the card, or the like to provide the customer with a hole punch, a stamp having an indication, or add points to the card, or the like.

In this way, a customer can accumulate hole punches, stamps, or points which can potentially lead to rewards. For example, a loyalty customer of a coffee shop may have a punch card. The punch card may provide that for each cup of coffee purchased, the customer receives a punch in the card. After the customer accumulates six punches in the card, the customer can then reveal the card for a free cup of coffee. In this way a customer can be rewarded for loyalty of purchasing coffee from that particular business. As another example, a customer may accumulate stamps or points on a card in the same way, such that the customer can reveal the stamps or points for a reward with a particular business.

In this way, loyalty cards have a long history going back to customers making promises to return to a business and businesses rewarding customers with food or drink and the like just for coming in regularly, as these may be considered early forms of loyalty type rewards. Some loyalty reward programs only exist online. Other loyalty programs are limited to frequent flier-like points. Other loyalty programs are limited to credit cards. Other programs are limited to a card that a user must remember to take with them to a merchant. Other programs are limited to magnetic strip scanning cards, stamp cards, or punch cards.

Loyalty programs and rewards programs have been an effective marketing strategy for some businesses over the years and since the inception of the loyalty rewards. However, many businesses complain that loyalty programs only benefit those who will be purchasing from the business anyway. Said another way, the business loses money because the customers now have a discount but will purchase the products and/or services anyways. Said another way, oftentimes businesses feel that loyalty programs, while they are a good marketing strategy, are not a good investment.

Another common complaint by businesses is that loyalty programs, rather than working as a true loyalty, only turn into a bargain in which customers are lured into purchasing products and/or services because the customers have been enticed by a sale. In the case of infrequent purchasers, or irregular customers, this does not entice loyalty for customers but rather only acts as a discount occasionally driving a customer to purchase goods and/or services from a business, much like a sale would.

Yet another common complaint with loyalty programs is abuse. Some loyalty customers may purchase ten cups of coffee to earn a discount but then use the discount on a very expensive item such as an espresso machine, which costs the business a great deal of loss. Another common complaint with loyalty programs are other forms of loyalty abuse and the like. On the other side of complaints are the customer side, which also carry a great number of frustrations with existing loyalty program types. These complaints and other longstanding problems with loyalty programs exist in the art and cause controversy within loyalty programs.

Thus, it is a primary object of this disclosure to provide a loyalty system, loyalty tracking system, merchant multi-use loyalty system, merchant offering platform, loyalty sharing system, loyalty platform, sharing network platform, commercial incentivising system, and methods of use which solves many of these long existing problems in the art and to provide a more flexible, respectful loyalty system which benefits businesses and customers alike.

### SUMMARY OF THE DISCLOSURE:

A loyalty system, loyalty tracking system, merchant multi-use loyalty system, merchant offering platform, loyalty sharing system, loyalty platform, sharing network platform, commercial incentivising system, and methods of use are presented. The loyalty system, loyalty tracking system, merchant multi-use loyalty system, merchant offering platform, loyalty sharing system, loyalty platform, sharing network platform, commercial incentivising system, and methods of use which solves many of these long existing problems in the art and to provide a more flexible, respectful loyalty system which benefits businesses and customers; thus in this way creating a better loyalty system to be adapted and used by varying merchants, customers and exchanged and shared between the like.

In one example, the loyalty system, loyalty tracking system, merchant multi-use loyalty system, merchant offering platform, loyalty sharing system, loyalty platform, sharing network platform, commercial incentivising system, and methods of use provides the state of the art with a base platform currency system which provides for using a percentage off of a future purchase with a merchant. This model, which provides a future percentage discount can be accumulated and redeemed within a predetermined set of parameters; which a business can set up.

Similarly, and in this way, the systems and methods of use provide a multi-use loyalty program, via a web link and/or scannable code, which can be claimed by a plurality of customers and/or individuals. Once a merchant creates this loyalty, a claimed loyalty can be redeemed much like a loyalty discount. However, this particular type of created and claimed loyalty cannot be accumulated and/or added to discounts which have been earned through spending. In this way, this platform is a single claim and single use type of offer and/or reward which can not be accumulated with other earned percentages. In this way, a merchant can truly customize specific offers or one time discounts through changing the value of the discounts, the types of discounts, the time the discounts can be redeemed, and a number of other parameters, applicable, for which a merchant may desire for any given offer. Said another way, this allows merchants and/or businesses to create promotional website links, create social media advertisement links, or print promotions on physical media as with a scannable code which can then control the amount of claims and value given without needing to reprint additional media and/or create additional advertisements.

In another example, the loyalty system, loyalty tracking system, merchant multi-use loyalty system, merchant offering platform, loyalty sharing system, loyalty platform, sharing network platform, commercial incentivising system, and methods of use provide the state of the art with a loyalty discount earning system. This system may be considered to operate like a digital stamp card. However, unlike anything found in the art, and in solving some long-standing needs of the art, this system can be shared with friends, can provide for earning bonuses, can be scannable for earning and redeeming and provides for enhanced synchronization, and can be modified such that after a period of time of loyalty a customer and/or user can make decisions related to their earned loyalties.

Said another way, the system provides for sharing with friends and others such that a user can see a leader board of friends, and loyalty discounts that those friends have earned, and likewise can request the friend share their loyalties with them. Likewise, a user can see ratings of businesses provided by other users. Similarly, friends can share flash offers with each other that they may not be able to access on their own.

Said another way, various types of loyalties and/or bonuses can be earned when a user refers another to the system. Additionally, various types of loyalties and/or bonuses can be earned when a user, optionally, shares a discount. Furthermore, various types of loyalties and/or bonuses can be earned when a user, optionally, is a staff member of a merchant and transacts with a customer using the systems and methods of use herein.

Said another way, when earning and/or redeeming transactions, the redeeming and/or other transactions can be handled on the platform using scannable codes and various devices which provide for near instantaneous synchronization. In this way, immediate synchronization can appear when a staff member issues new loyalty to new users. In this way, immediate synchronization can occur when a staff member issues a new and/or additional loyalty to an existing user.

Said another way, the redeeming and/or other transactions through the platform can be handled through a scannable code which provides that a user can request to burn and/or redeem loyalties through messaging staff. In this way, the system and platform provides for the synchronization of staff of a merchant with the loyalty program of a customer. In other words, the staff receives a push notification that the customer wants to redeem and/or burn a loyalty. Additionally, the platform provides for payment processing and transactions such that a customer can pay directly through the platform.

In another example, the loyalty system, loyalty tracking system, merchant multi-use loyalty system, merchant offering platform, loyalty sharing system, loyalty platform, sharing network platform, commercial incentivising system, and methods of use provides for customization of loyalty programs and decision making regarding loyalties. Said another way, after a period of time of loyalty, a customer and/or user can choose their own referring user, meaning the friend of their choice who will receive the loyalty bonuses where they spend/earn.

Said another way, the present platform provides various gamification-like advances that encourage networking and growth of the system. In this way, users can unlock various features and functionalities by representing and growing their transaction numbers, by having positive ratings, by referrals of other users and businesses, and also by sharing rewards, and the like. In this way, the platform encourages natural growth and use. Additionally, in this way, the system becomes fun to use for users, merchants, and the like.

In one example, the loyalty system, loyalty tracking system, merchant multi-use loyalty system, merchant offering platform, loyalty sharing system, loyalty platform, sharing network platform, commercial incentivising system, and methods of use functions and provides the art with a sharing network. Said another way, the system can be used as an input for the creation of offers and loyalties. In this way, a merchant can use the system to generate sales and automated advertising. In other words, when a merchant creates an offer, they can also control who the offer is pushed out to through audience control. This unique feature allows businesses to control who receives the offer.

Said another way, a merchant can control what type of customers receive the offer, whether the customer is a previous customer, a recently visited customer, a new customer, a highly rated customer, a frequent customer, a staff of a merchant, a staff of a nearby merchant, a friend of the merchant, any other parameter, and the like.

Said another way, businesses and/or merchants can build an engagement with their most preferred customers, if desired. In this way and through the platform, the businesses and/or merchants can share benefits to customers with a preferred status, with friends of preferred customers, or share with others of certain status, and allow friends to access the deals of the merchant under a set of rules and/or qualifications of a customer and/or user.

Additionally, in one arrangement, the present system provides a platform so that staff and/or merchants can rate customers. In this way, the ratings of customers by merchants may also be a parameter for determining whether or not a particular customer and/or user is provided access to an offer.

In another example, the loyalty system, loyalty tracking system, merchant multi-use loyalty system, merchant offering platform, loyalty sharing system, loyalty platform, sharing network platform, commercial incentivising system, and methods of use provides a sharing network that can be used for a user and/or customer to provide ratings for businesses and/or merchants. In this way, a user can have instant access to trusted reviews, such as reviews by friends at particular merchants. In this way, a user can instantly get access to what friends have rated which merchants.

Additionally, in this way, a merchant and/or business can have valuable feedback, which is limited to friendship groups and may be private and/or kept from the public and/or other public rating and review channels. This type of feedback can be more valuable to merchants than public feedback.

Additionally, in this way, the platform also provides for followers. In this way, the followers and/or users can track friends, track visits of others, and view ratings of friends. In this way, a user and/or customer can follow others, such as a “foodie” and get access to various lists and additional information.

In another example, the loyalty system, loyalty tracking system, merchant multi-use loyalty system, merchant offering platform, loyalty sharing system, loyalty platform, sharing network platform, commercial incentivising system, and methods of use provides a means of sending offers and loyalties to a user and/or set of users based on a discount level threshold.

Said another way, and by example, a first user who has signed up for push notifications and/or notifications and/or emails and the like about offers from a particular merchant can limit offers from a merchant to a particular threshold such as a minimum of 30% and the like. As another example, if a first user has set her offer greater than 10% for more favored businesses, then she can set the threshold globally for all businesses she has not individually configured, if she so wishes, thus providing further customization for a user. This may be beneficial for a user such that market data can be provided to a merchant such that a merchant actually knows how many users the offer will reach. In yet another example, a merchant and/or customer and/or user can control offers sent and/or offers received based on distance. Said another way, a merchant may control sending offers to customers within a particular distance. Said another way, a customer may control receiving offers from merchants within a particular distance. Furthermore, and in another example of offer parameters, a user can limit the time of day they receive offers or the validity of the time the offers are for.

In another example, the loyalty system, loyalty tracking system, merchant multi-use loyalty system, merchant offering platform, loyalty sharing system, loyalty platform, sharing network platform, commercial incentivising system, and methods of use provides for the spreading and sharing of the platform through incentivising referrals, incentivising sign-ups, incentivising offer sharing, incentivising businesses, incentivising merchants, and other incentivising and incentivising programs.

Some of the incentivizing programs include but are not limited to, loyalty transactions for monthly subscriptions, loyalty for volume related efforts, loyalty for signing up additional users, offers for previous redemptions, bonus offers for redemption thresholds, home customer features which tie a user to a merchant, additional promotions such as showing up first for an offer, additional promotional rights for certain time periods, additional promotions for business choices, gamification elements, transaction numbers, rating numbers, referral numbers, sharing quantity, unlockable features, and the like. Additionally, loyalty and/or multi-use codes and benefits may be provided.

In another example, the loyalty system, loyalty tracking system, merchant multi-use loyalty system, merchant offering platform, loyalty sharing system, loyalty platform, sharing network platform, commercial incentivising system, and methods of use provides a business referral system and model which allows a user to invite and/or provides incentives when a merchant encourages other merchants to join the platform.

Thus, it is a primary object of the disclosure to provide a loyalty system, loyalty tracking system, merchant multi-use loyalty system, merchant offering platform, loyalty sharing system, loyalty platform, sharing network platform, commercial incentivising system, and methods of use that solves long felt needs in the loyalty art by providing unique solutions, unique features, unique functionalities, and the like.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a platform base currency as a percentage of future purchases.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a platform base currency as future product and/or services of future transactions.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for loyalty earning.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provide for loyalty accumulation.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a platform for redeeming loyalties.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a platform for business configurable parameters.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for a maximum redemption percentage of loyalties.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for a maximum dollar amount which can be redeemed as a loyalty on a single visit.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for a parameter which provides a configurable earn percentage based on the amount spent at a single merchant at a given time.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for a multi-use loyalty platform.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for a loyalty platform for use with website links and/or scannable codes.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for loyalties which can be claimed by a plurality of customers from a single scannable code.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a merchant the ability to change a loyalty discount value prior to redemption.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a merchant the ability to control an available number of offers and/or number of loyalties available at a given time.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for promotional link and/or social media link creation for advertising and/or promotional purposes.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for loyalty discounts like a stamp card which can be earned.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a leader board.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides with loyalty sharing.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for merchant rating.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides customer rating.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides loyalty sharing among friends.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides sharing flash offers among friends and others.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provide bonus earnings.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides loyalty earnings for referring other customers to the platform.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for loyalty earnings for referring other merchants to the platform.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for loyalty earnings on an accumulation basis.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for redemption of loyalties using a scannable code.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provide for loyalty redemption instantly through the platform.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a loyalty program for staff and/or employees.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that incentivizes staff and/or employees to sign up customers to the platform.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that incentivizes referrals.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that allows for users to burn loyalties at the time of payment for goods and/or products and/or services.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides a messaging platform for customers to directly contact merchants and/or for merchants to directly message customers.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for customers to directly share loyalties with other customers.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for customers to directly request loyalties from other customers.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for merchants to directly share loyalties to customers.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for merchants to send offers.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for merchants to send offers to a specified group of customers.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides for staff to earn loyalties based on customer referrals.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that improves upon the state of the art.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that is optimized and/or compatible with smartphone technology.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provide machine learning.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that implements geographic location and/or global positioning.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that learns patterned behavior of users and/or merchants.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that improves upon the state of the art.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides unique features to the state of the art.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that solves long felt needs in the state of the art.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that is easy for a business to use.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that is easy for a merchant to use.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that is easy for a customer to use.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that are efficient.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that are robust.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that are accurate.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provide for quantity and information tracking.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that saves time for a merchant.

Another object of the disclosure is to provide a loyalty system, loyalty tracking system, merchant multi-use loyalty system, merchant offering platform, loyalty sharing system, loyalty platform, sharing network platform, commercial incentivising system, and methods of use that provides advertising for a merchant.

Yet another object of the disclosure is to provide a loyalty system, loyalty tracking system, merchant multi-use loyalty system, merchant offering platform, loyalty sharing system, loyalty platform, sharing network platform, commercial incentivising system, and methods of use that provides solutions to the various aspects of rewards program abuse which takes place in the state of the art.

These and other objects, features, or advantages of the present disclosure will become apparent from the specification and claims.

### BRIEF DESCRIPTION OF THE DRAWINGS:

FIG. 1 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing a user; the illustration showing a merchant; the illustration showing some of the interactions of a user and a merchant within system 10.

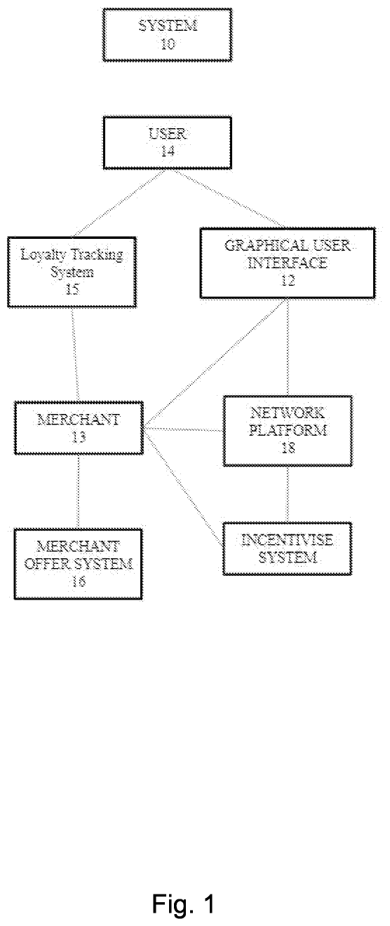

FIG. 2 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing the main pages of the graphical user interface.

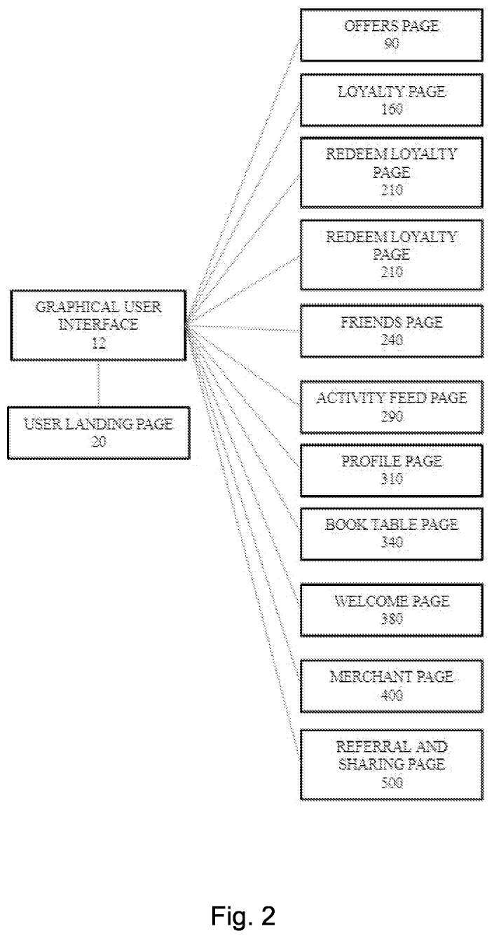

FIG. 3 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the landing page.

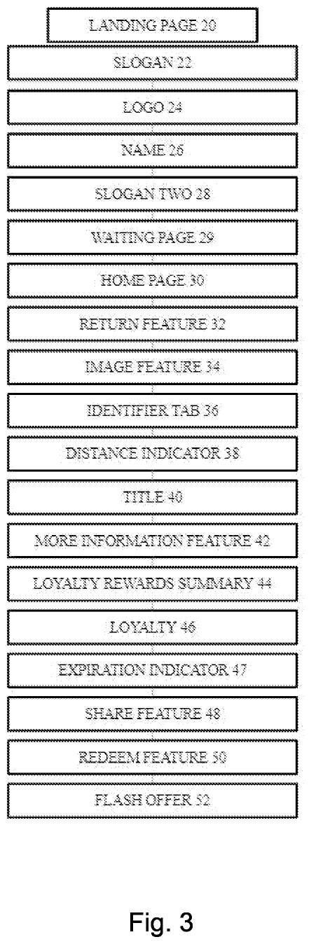

FIG. 4 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the landing page.

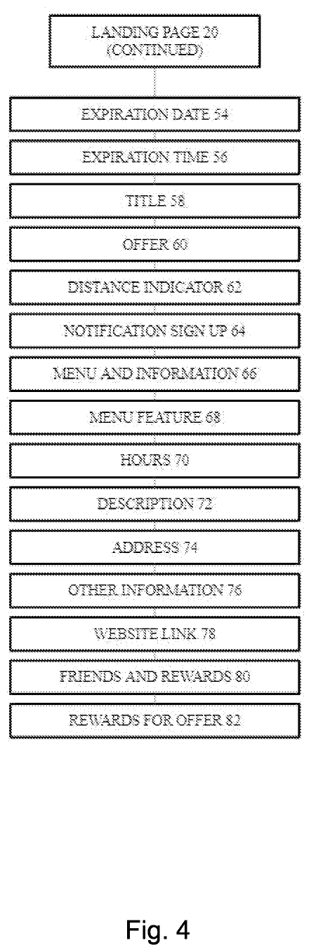

FIG. 5 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the offers page.

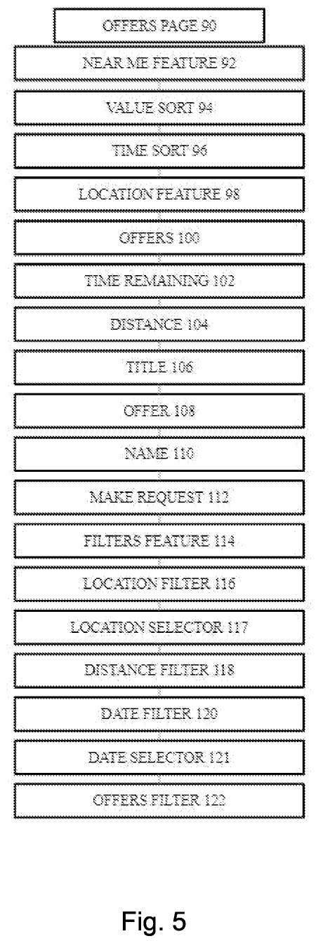

FIG. 6 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the offers page.

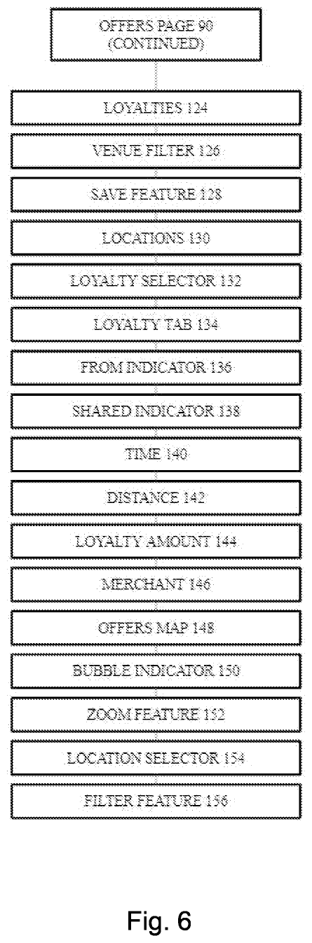

FIG. 7 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the loyalty page.

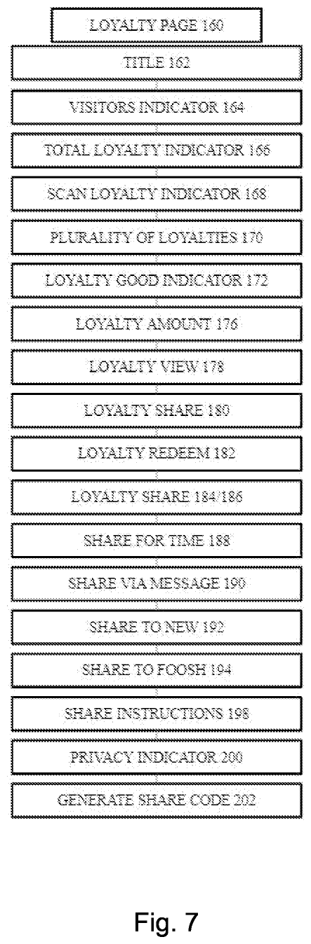

FIG. 8 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the redeem loyalty page.

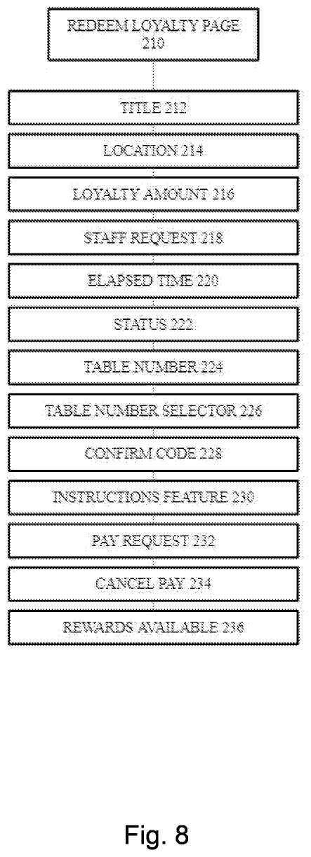

FIG. 9 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the friends page.

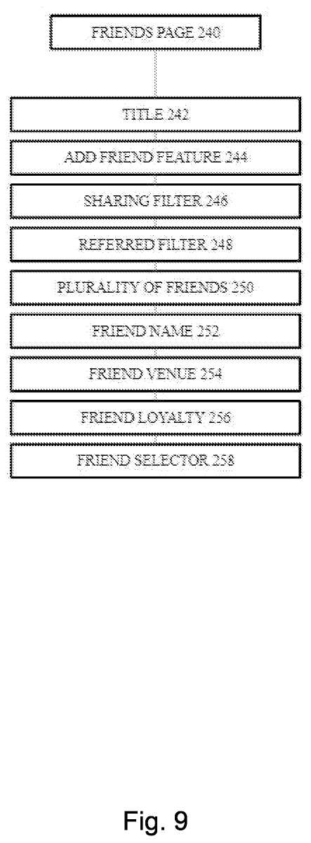

FIG. 10 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the individual friend page.

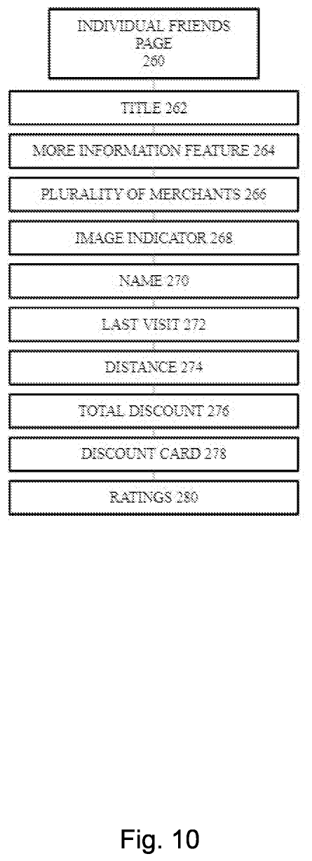

FIG. 11 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the activity feed page.

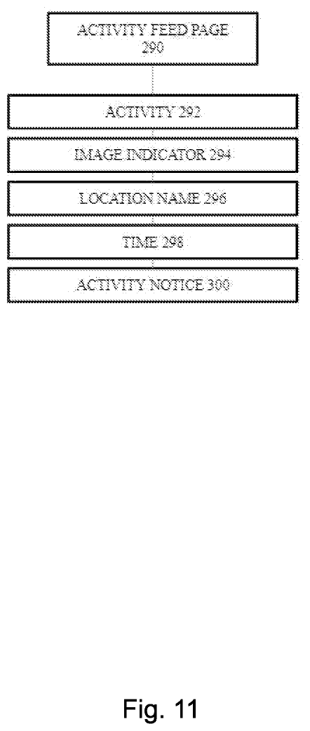

FIG. 12 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the profile page.

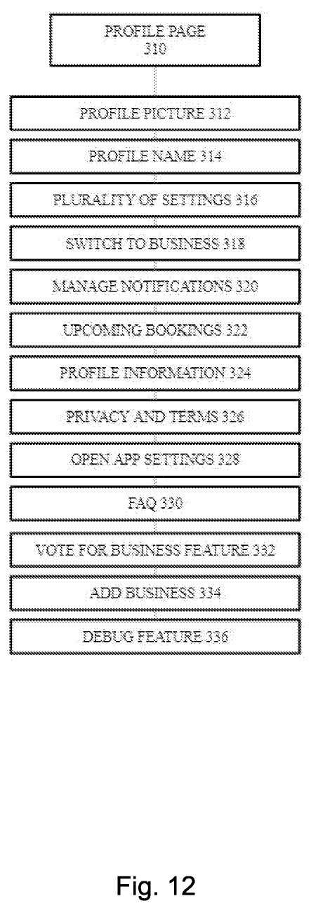

FIG. 13 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the book table page.

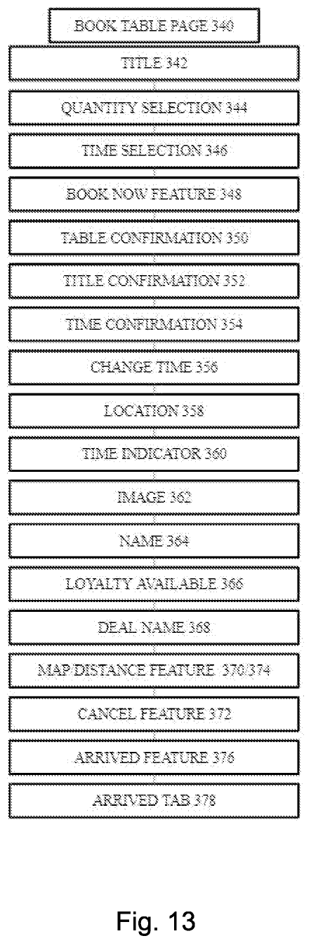

FIG. 14 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the welcome page.

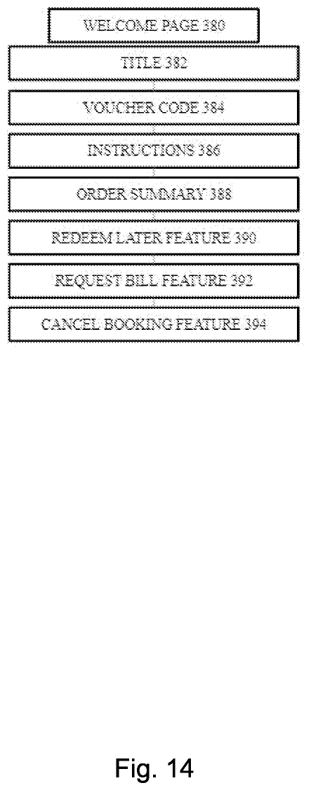

FIG. 15 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the merchant page.

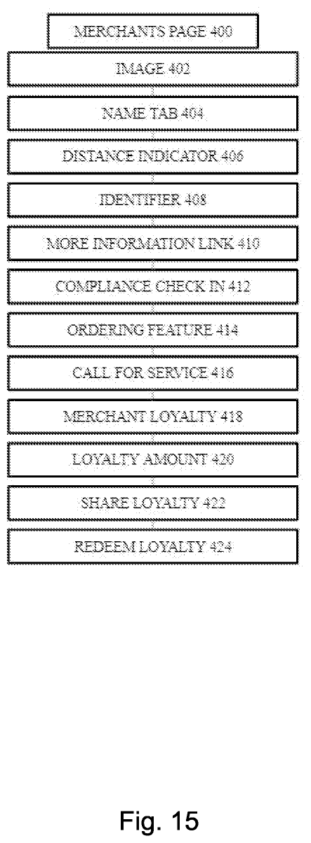

FIG. 16 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing some of the features and functionalities of the referral and sharing page.

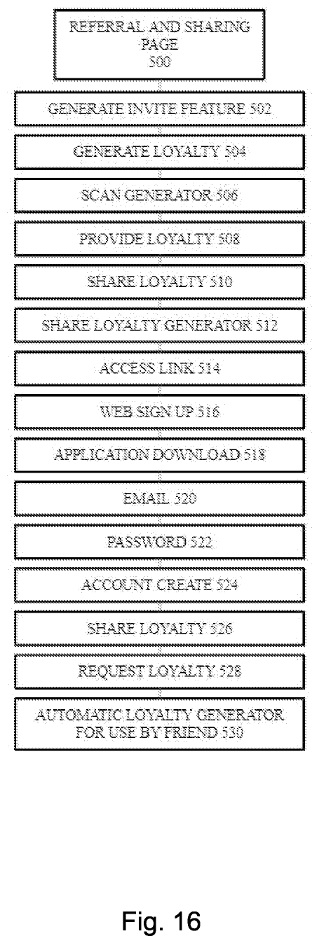

FIG. 17 is an illustration of the loyalty system; the illustration showing a loyalty system, loyalty tracking system, merchant multi-use loyalty system, merchant offering platform, loyalty sharing system, loyalty platform, sharing network platform, commercial incentivising system, and methods of use; the illustration showing an application server; the illustration showing a remote server; the illustration showing a computer; the illustration showing an application programming interface; the illustration showing cloud computing.

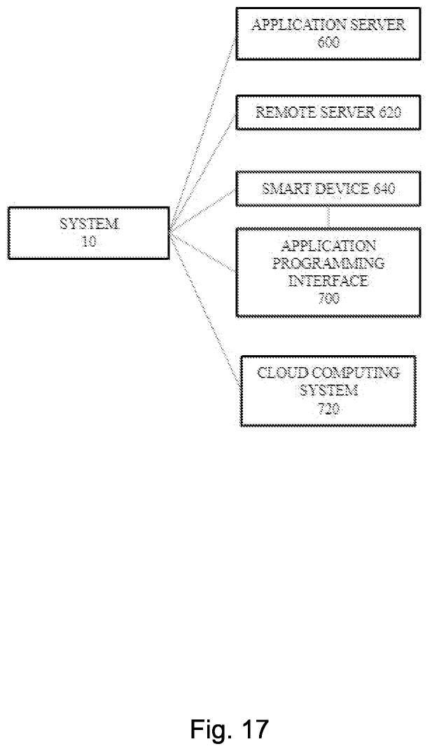

### DETAILED DESCRIPTION OF THE DISCLOSURE:

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Loyalty system, loyalty tracking system, merchant multi-use loyalty system, merchant offering platform, loyalty sharing system, loyalty platform, sharing network platform, commercial incentivising system, and methods of use may be formed of any suitable size, shape and design and are configured to provide a unique merchant and/or consumer loyalty system that enables loyalty sharing and customization. These features, functionality, among customization features and many other unique features are presented herein.

Loyalty system, loyalty tracking system, merchant multi-use loyalty system, merchant offering platform, loyalty sharing system, loyalty platform, sharing network platform, commercial incentivising system, and methods of use is configured to integrate with various platforms and/or accept various input and produce various outputs to allow users to scale information by dynamically modifying loyalty rewards, particularly sharing loyalty rewards, requesting the sharing of loyalty rewards, and generating loyalty rewards.

Loyalty system, loyalty tracking system, merchant multi-use loyalty system, merchant offering platform, loyalty sharing system, loyalty platform, sharing network platform, commercial incentivising system, and methods of use includes the ability for merchants to interact dynamically with the various systems via creating flash offers, creating loyalties, incentivising clients and/or customers in various ways, incentivising new clients and/or customers in various ways, and sharing loyalties, as well as enabling staff to gain loyalties by sharing loyalties and/or engaging customers.

Loyalty system, loyalty tracking system, merchant multi-use loyalty system, merchant offering platform, loyalty sharing system, loyalty platform, sharing network platform, commercial incentivising system, and methods of use dynamically integrates merchants, businesses, projects, locations, merchant information, payment information, vendor information, product information, client information, customer information, and other information.

Additionally, loyalty system, loyalty tracking system, merchant multi-use loyalty system, merchant offering platform, loyalty sharing system, loyalty platform, sharing network platform, commercial incentivising system, and methods of use dynamically integrates merchants, businesses, projects, locations, merchant information, payment information, vendor information, product information, client information, customer information, and other information by allowing a user to input various information in its component parts, share various component parts, and modify each component part individually, tailoring it to the needs of the user, merchant, or customer. In this way, the disclosure herein can take loyalty sharing information, advertisement information, merchant information, customer information and/or other information as input and simplify and improve the management of solicitation, loyalty earning and redemption, and promotions and payment procedure into a fun, easy to use, smart and efficient loyalty program and loyalty platform.

System:

With reference to the figures, a loyalty system, loyalty tracking system, merchant multi-use loyalty system, merchant offering platform, loyalty sharing system, loyalty platform, sharing network platform, commercial incentivising system, and methods of use 10 are presented (hereafter known as “loyalty system”, “rewards system”, “loyalty sharing system”, “loyalty sharing platform”, “loyalty platform” or simply “system”). Rewards system 10 is formed of any suitable size, shape and design.

In the arrangement shown, as one example, loyalty sharing system 10, which may comprise remote servers, databases, application servers, application databases, product databases, mobile applications, merchant databases, customer database, networking application servers, and/or computers that fulfill the functions disclosed herein, also includes, in the embodiment(s) depicted by example which includes, but is not limited to a graphical user interface 12, a merchant 13, a user 14, a loyalty sharing and/or tracking system 15, a merchant offer system 16, a network platform 18, and an incentivisation system 19, among other components, features, and functionalities.

In the arrangement shown, as one example, system 10 comprises remote servers, databases, and/or computers that fulfill the functions disclosed and described herein. The appearance of the presentation of merchant information and/or customer information and/or loyalty information and/or the process windows for uploading and/or adding information to the system and or retrieving and/or displaying information and/or data related to the system 10 may vary.

Merchant:

In the arrangement shown, as one example, system 10 includes a plurality of merchants 13 (also known as a “business” or “businesses”). Merchant 13 may be any merchant which is to be engaged with the system 10 at a future time or is currently offering products and/or services through the system. In this way, a merchant 13 is offering loyalty rewards and or offering flash sales through the system 10.

As one example, and as shown in the arrangement herein, a merchant 13 may be a coffee shop offering loyalty rewards earned. As another example, a merchant 13 may be a restaurant serving food and/or beverages. As another example, a merchant 13 may be a hair salon and/or beauty parlor. As another example, a merchant 13 may be a sporting goods shop. As another example, a merchant 13 may be an internet provider. Said another way, a merchant may be any business or operation of a business that is providing some type of product and/or service, and the like.

User:

In the arrangement shown, as one example, system 10 includes a plurality of users 14. User 14 is typically a user engaging with and/or utilizing system 10. Said another way, a user 14 is a user, typically, engaging with the graphical user interface 12 and/or visiting a merchant and/or providing and/or receiving products and/or services from a merchant and/or customer. In the arrangement shown, as one example, a user is an individual wishing to engage with the loyalty program, whether to earn rewards, receive offers, provide advertising, provide promotions, and the like.

As another example, a user may be any merchant and/or customer and/or staff interacting with the system. This need not be through the graphical user interface 12 because a user attending a restaurant to eat or consume a beverage or food, by example, may be engaging with the system without using their smartphone or other device at a certain time.

Loyalty Sharing System:

In one embodiment, and in the arrangement shown, as one example, system 10 includes a loyalty system 15 (also known as a “loyalty tracking system” and “loyalty sharing system”). Loyalty sharing system 15 is formed of any suitable size, shape, and design and is configured to allow users to earn loyalties, accumulate loyalty rewards, and share those rewards with other users. Additionally, loyalty sharing system 15 is configured to allow a user to request loyalty rewards be shared with them from another user 14.

Furthermore, in the arrangement shown, as one example, the loyalty system 15 is configured to provide a platform currency which is a percentage off future purchases. This model and in the arrangement shown, as one example, allows a user to accumulate and redeem percentages off future purchases with a business and/or merchant within configurable parameters.

While a percentage off a future purchase is considered here by example, other loyalty arrangements are also considered for use. These may be future items for free such as a coffee, a haircut, other products, other services, and the like. Additionally, this may be a point system, or configured as another earnings system as well. These and other earnings are hereby contemplated for use.

In the arrangement shown, as one example, loyalty system 15 includes a number of configurable parameters. Some of these parameters, and in the arrangement shown, as one example, are a maximum redeemable percentage at a single visit. In other words, a user may accumulate loyalty percentages but be limited to what quantity of the percentage can be redeemed on a single visit. As another example, and in the arrangement herein, a maximum redeemable dollar amount per visit can be instituted as a redeemable configured parameter. For example, a user may have 200% of loyalty earned, but may be limited to redeeming a percentage value equal to $5 or $10 or the like on a single visit. As another example, and in the arrangement herein, a certain percentage of loyalty rewards can be earned per spend. As one example, a user may be able to earn 1% for future loyalty for every $1 spent, or 1% loyalty for every $5 spent, or 5% loyalty for every $100 spent, or the like. These and other loyalty rewards and/or other configurable parameters are hereby contemplated for use along with various other configurable parameters as may be desired.

Loyalty Sharing: In the arrangement shown, as one example, loyalty system 15 includes a plurality of variations on sharing loyalty discounts and other earned rewards. In the arrangement shown, as one example, loyalty discounts earned can be shared with friends. In this arrangement, as one example, a user has access to a leader board of friends (to be further discussed herein) and a list of friends (to be further discussed herein. In this example, a user can select a friend from either the leaderboard and/or the friends list and choose to share an earned loyalty with this friend. The loyalty can be shared for a particular time duration and the like. (to be further discussed herein). Similarly, a user can view what merchants the friend rates well and see if the friend has loyalties at that well rated merchant (ratings and networking features to be further discussed herein).

In the arrangement shown, as one example, loyalty system 15 includes a request loyalty sharing feature. In this arrangement, a user can request a friend share a loyalty discount from a particular business, for a particular amount, and the like with them. This can be a very unique method of sharing when a user wishes to go to a particular merchant and wants a discount at the merchant. This is one example of how a user can request a friend share a loyalty and/or reward with them.

In the arrangement shown, as one example, similarly to how a user can request a loyalty percentage, a user can also request offers a friend may have in their rewards bag and/or an offer asset the friend may own (offers to be further discussed herein; flash offers to be further discussed herein). Similarly, a user can share their offers and/or flash offers with other users as the user desires.

Additionally, and in the arrangement shown, as one example, loyalty discounts can be earned for referring other users to the platform 10. Additionally, and in the arrangement shown, as one example, loyalty discounts can be earned for sharing a loyalty and/or sharing an offer with another user. Additionally, and in the arrangement shown, as one example, loyalty discounts can be earned for being staff of a merchant and transacting with customers, other staff, and other users through the platform. These and other means of earning loyalty rewards are hereby contemplated for use.

In the arrangement shown, as one example, earning and/or redeeming loyalty rewards and/or transactions can be handled in a variety of ways. In the arrangement shown, earning and/or redeeming loyalty rewards and/or transactions are handled in one of two ways. The first is through scannable codes. In this way, and as shown in example, a first user can scan a code provided by a second user and/or merchant. As another example, earning and/or redeeming and/or sharing loyalty rewards and/or transactions can be delivered from a first user and/or merchant to a second user and/or merchant instantly through device synchronization through the platform. These and other sharing and transaction means are hereby contemplated for use.

Said another way, and in the arrangement shown, as one example, earning and/or redeeming transactions are handled through scannable codes and/or device synchronization so staff of a merchant can issue new loyalty to new users. As another example, earning and/or redeeming transactions are handled through scannable codes and/or device synchronization so staff of a merchant can issue new loyalty to existing users. As another example, earning and/or redeeming transactions are handled through scannable codes and/or device synchronization so a user can request to “burn” (or redeem) a loyalty via a message to a merchant and/or merchant staff that synchronizes the devices when payment is confirmed. As another example, earning and/or redeeming transactions are handled through scannable codes and/or device synchronization so payments can be made directly through the platform with loyalty discounts being applied at time of payment.

In the arrangement shown, as one example, loyalty discounts and rewards can be a part of a gamification and/or unlocking system such that loyalty discounts can be earned in gamification and/or unlocking means. As one example, after a set period of time of using the platform, a user may choose a referring user, meaning that a user can choose a friend who will receive loyalty discounts on their behalf at a particular merchant each time the user spends and/or earns a discount at the merchant. Said another way, as one example, when a first user refers a second user to the platform, the first user will earn a percentage, for example 1% loyalty, at a particular merchant for each time the second user spends at the particular merchant and/or at any merchant. After using the system for a particular duration of time, the second user can unlock who receives the 1% loyalty at the merchant the second user visits. So for example, the second user can designate a third user to start receiving the 1$ loyalty reward and/or continue to change who receives this loyalty reward. This is one example of unlocking features and the like for which a user can gain advantages and earn loyalty rewards with friends in system 10. Other examples are also hereby contemplated for use and a number are shown by example herein. Some of these include super users, high transaction numbers, best rating parameters, most referrals, referral milestones, share milestones, earning milestones, and the like.

Multi-Use Loyalty Feature: In the arrangement shown, as one example, loyalty system 15 includes a multi-use loyalty which may be configured by a merchant or the like. In the arrangement shown, as one example, a multi-use loyalty and/or promotion code might be in the form of a website link, such that a user can click the link, and/or might be in the form of a scannable code such that a user can scan the code to claim the loyalty and/or promotion. In this way, multiple people can scan any code or click any website link in order to claim the promotion and/or loyalty. In this way, and in the arrangement shown, as one example, once a user claims the multi-use loyalty, the user has a redeemable loyalty reward of whatever the percentage amount is or whatever the promotional value is of the multi-use loyalty. In one arrangement, the user is not allowed to add this particular multi-use loyalty to other earned loyaltys. However, this may be an option depending on whether the merchant desires this configurable parameter. In this way, a merchant can generate promotional discounts and send out a certain number of multi-use loyalties to generate additional revenue. These multi-use loyalties and/or codes can be changed at any time by the merchant and can be limited to a maximum number of users. In one arrangement, the multi-use loyalties are provided on a first come first served basis such that perhaps only 10 users can claim the loyalty, or perhaps 20 users, or perhaps 1,000 users, or any other number of users as the merchant desires, through the use of a configurable parameter. Additionally, and in this arrangement, a merchant can use these codes on social media, print advertisements, sharing a code in real-time, and the like in order to promote a merchant. Additionally, and in this way, a user can control the amount of claims and the value of each loyalty claimed without having to reprint media, and the like. These and other functions, capabilities and features of a multi-use loyalty are hereby contemplated for use.

Merchant Offer System:

In one embodiment, and in the arrangement shown, as one example, system 10 includes a merchant offer system 16 (also known as “advertising system”, “promotion system”, or simply “offer system”). Offer system 16 is formed of any suitable size, shape, and design and is configured to provide a system and platform for which merchants can customize and provide offers to customers and/or potential customers.

In the arrangement shown, as one example, merchant offer system 16 provides a means for businesses and/or merchants to create offers. An offer is a simple, single current of discount percentage, while also providing the merchant with an opportunity to provide a discount on a specific product (such as a product with a higher margin) as opposed to having to offer loyalty discounts on a percentage of an entire bill and/or offering percentages of discount on items which have a lower margin, and the like.

In the arrangement shown, as one example, a merchant can dictate the audience to receive the offer. In this way, the merchant offer system 16 can control who receives or which users can claim an offer. Said another way, the sharing network of the platform can be used as an input to the offer audience feature. In this way, when the merchant creates an offer, the merchant can dictate, through a plurality of configurable parameters, which groups and/or friends and/or users will receive and/or have access to the special offer.

In the arrangement shown, as one example of a configurable parameter associated with offers is a group such as a group of previous customers that have had transactions with the merchant in the past, and/or a group of customers that have a threshold rating, and/or a group of regular and/or frequent customers which attend so often over a period of time, and/or staff of the merchant, and/or staff of a particular merchant, and/or friends of staff of the merchant, and/or friends of staff of a particular merchant, and/or another group of users. Furthermore, and in the arrangement shown, as one example, the merchant staff can rate the customers on a scale. The ratings of the customers can then be a parameter used in filtering audiences in the system 16.

In this arrangement, and as shown in the example, a merchant can build business through their engagement with preferred customers and/or users and allow these customers and/or user to share the benefits of the preferred status with friends and/or allow friends to access preferred deals (or “offers”).

In the arrangement shown, as one example, system 16 includes a plurality of notifications. Plurality of notifications are formed of any suitable size, shape, and design and are configured and/or can be configurable such that a merchant can send offers to a user and/or group of users based on user discount level threshold. Said another way, and by example, a first user can say that they only want push notifications on the platform and/or email notifications from the platform for offers from a first merchant if the offer is greater than 30% and/or a threshold monetary value, such as $10. These and other thresholds and other threshold parameters are hereby contemplated for use as configurable parameters for a user in managing notifications received. Furthermore, and in another example, a first user can set one threshold for a preferred business and a second threshold for all other businesses and the like. Additionally, the platform can provide this information to a first merchant so that a merchant knows what and how many users any given offer will be sent to. This data can be shared and the number of users a particular offer will reach can be viewed. These and other offer notifications can be managed in various ways with various settings on both merchant and user and/or customer ends. Furthermore, other parameters are hereby contemplated for use such as offers associated with lunch time or dinner time and the like.

Network Platform:

In one embodiment, and in the arrangement shown, as one example, system 10 includes a networking platform 18 (also known as “networking system”, “rating system”, “friend platform” or simply “network system”). Networking system 18 is formed of any suitable size, shape, and design and is configured to provide various networking and/or interactions amongst groups and friends (to be further discussed herein).

In the arrangement shown, as one example, friends can view each other's profiles, loyalty accumulations, favorite merchants, request loyalties, and view ratings the friends have provided for merchants amongst many other functional and fun interactions. In the arrangement shown, as one example, the networking system 18 includes a ratings system. Ratings system is formed of any suitable size, shape, and design and is configured to accept and display various ratings by users to be shared in the network. Said another way, the sharing network and/or network platform 18 can be used by a user to share ratings of businesses within a friendship group and/or group. In the arrangement shown, as one example, this feature provides trusted reviews to users, as the reviews come from known colleagues, acquaintances, and/or other trusted users. In this way, the user can also see which friends rated certain businesses, how many times a friend has visited a particular merchant, and/or make determinations on merchants to visit based on this information. In the arrangement shown, as one example, this private rating system has many advantages above the various public ratings systems, as is shown herein. Furthermore, and in the arrangement shown, as one example, may have followers and/or be followed by other friends. These and other features of a rating system are hereby contemplated for use.

Incentive System:

In one embodiment, and in the arrangement shown, as one example, system 10 includes an incentive system 19 (also known as “incentivising system”, “incentivisation system”, “incentivisation method of use” or simply “incentives”). Incentive system 19 is formed of any suitable size, shape, and design and is configured to provide a plurality of incentivizing mechanisms so that users refer the system to other users, so that users sign up to use the platform, so that merchants sign up to use the platform, so that merchants encourage users to sign up to and use the platform, so that merchants encourage other merchants to sign up and use the platform, so that users are incentivized to visit merchants, so that merchants are incentivized to visit merchants, so that users are incentivized to share loyalties with other users, so that merchants are incentivized to share loyalties, a combination thereof, and the like.

In the arrangement shown, as one example, the platform 10 is designed to spread throughout and grow rapidly in user number due to the referral sign ups, offer sharing, and other incentive programs and designs. As one example, and in the arrangement shown, all loyalty transactions are covered in a fixed monthly subscription to the platform. In this way, the merchants have no volume related costs to giving loyalty and signing up users, thus encouraging an incentive. Additionally, and in the arrangement shown, as one example, offers redeemed on the platform have a per redeemed booking charge to the business, so this further incentives. As another example, and in the arrangement shown as one example, when a merchant signs up a new customer, the merchant becomes the “home” of the user. In this way, the merchant will only pay a minimal amount for a redeemed offer and/or a discounted amount for a redeemed offer when a loyalty is transacted between that customer and the merchant. This incentivises the business to race to sign up as many customers as possible such that the merchant will be the “home” for the customers. Additionally, and in the arrangement shown, home merchants get additional promotion rights in the platform because their business profile will show up first every time that particular user and/or customer opens the platform. This creates additional advertising and the like. Additionally, and in the arrangement shown, the home merchant can be an incentive to a user to use the platform. As a user earns through gamification and other incentives, a user may be allowed to change their home merchant to any merchant they desire. Similarly, super users, high transaction numbers, best ratings, most referrals, most shares, and the like can unlock these and other features sooner than other users. This further incentives and gamifies the systems disclosed herein.

In the arrangement shown, as one example, businesses and/or merchants are incentivized to join and/or encouraged to join the platform because a user will encourage businesses and/or merchants to join the platform. In the arrangement shown, as one example, a user who invites a merchant to join the platform receives a reward of a loyalty percentage and/or loyalty reward for the business. Additionally, the user receives additional rewards for signing up multiple businesses and/or merchants. Additionally, a user can receive percentage fees that typically go to a merchant if that user refers to the merchant, further incentivizing users to invite merchants and merchants to join the system sooner. Furthermore, owners of multiple merchants can receive discounts by signing up their plurality of merchants.

In the arrangement shown, as one example, merchants get incentives for inviting users to join. For example, a merchant can receive percentage rewards for every percentage and/or loyalty a user earns which that particular merchant brought into the system. In this way, users can incentive merchants and merchants can incentivise users because each will benefit from the other joining and using the system.

These and other systems are contemplated for use and will be discussed in further detail in the disclosure herein.

Graphical User Interface:

In the arrangement shown, as one example, system 10 includes a graphical user interface 12. Graphical user interface 12 is formed of any suitable size shape and design and is configured to allow a user and/or merchant to view various loyalty information, accumulate loyalties, access offers, network on the networking system, invite others to join, earn rewards, and the like, and view other information related thereto, and/or view various maps and/or view various documents and/or manage loyalties and/or manage people and/or friends, and the like.

Graphical user interface 12 is an exemplary method by which systems of the present disclosure may be accessed and interacted with. Additionally, graphical user interface 12 provides the functionality and may provide scannable codes and direct synchronization of information through cellular and/or other connections.

In the arrangement shown, as one example, graphical user interface 12 includes a landing page 20, an offers page 90, a loyalty page 160, a redeem loyalty page 210, a friends page 240, an activity feed page 290, a profile page 310, a book table page 340, a welcome page 380, a merchant page 400, and a referral and sharing page 500, among other features, components, pages, and functionalities.

Landing Page: In the arrangement shown, as one example, graphical user interface 12 (or simply “interface”) includes a landing page 20 (also known as splash page 20). In the arrangement, as one example, landing page 20, is generally the landing page which a user is first directed to so that a user can login, change profiles or select from other quick navigation options. Additionally, a create account page 24 is also available to a user.

In the arrangement shown, as one example, landing page 20 includes, but is not limited to a slogan 22, a logo 24, a name feature 26, a second slogan feature 28, a waiting screen 29, and a home page 30, a return feature 32, an image feature 34, an identifier tab 36, a distance indicator 38, a title 40, a more information feature 42, a loyalty rewards summary tab 44, a loyalty feature 46, an expiration of loyalty indicator 47, a share feature 48, a redeem feature 50, a flash offer 52, a date of expiration of flash offer feature 54, a time of expiration of flash offer feature 56, a title 58, an offer feature 60, a distance indicator 62, a notification sign up feature 64, a menu and information tab feature 66, a menu feature 68, an hours of operation indicator 70, a business description feature 72, an address of business feature 74, an other information feature 76, a website link feature 78, a friends and rewards at location tab 80, and a rewards for offer at location feature 82, among other features, components, and functionality.

Offers Page: In the arrangement shown, as one example, graphical user interface 12 includes an offers page 90 (also known as “flash offers page” or “flash deal page” or simply “deal page”). Offers page 90 is formed of any suitable size, shape, and design and is configured to provide a flash offer and/or offer by a merchant to a customer. In other words, the offer page provides a flash offer and/or coupon which a customer may be able to select and later redeem for the goods and/or services associated with the flash offer.

In the arrangement shown, a flash offer appears as a type of advertisement which reflects a discount or other type of special offer on a good and/or service. Additionally, in the arrangement shown as one example, the flash offer includes a merchant name offering the offer, a time the offer expires, may include a deadline by which the offer must be redeemed, and may also include a distance from the customer to the merchant, among other information, functionality, and the like.

In the arrangement shown, was one example, flash offers page 90 includes, but is not limited to, a near me feature 92, a value sort feature 94, a time of day sort feature 96, a location map feature 98, an offer or plurality of offers 100, a time remaining for claim feature 101, a time remaining for redemption feature 102, a distance indicator 104, a title 106, an offer 108, a name 110, a make request feature 112, a filters and/or sort feature 114, a location filter 116, a location selector 118, a distance filer 118, a date filter 120, a date selector feature 121, an offers filter 122, a loyalties filter 124, a venues filter 126, a save sort feature 128, a locations feature 130, a loyalty selector of offers page feature 132, a loyalty tab 134, a form indicator 136, a shared indicator 138, a time feature 140, a distance feature 142, a loyalty amount 144, a merchant indicator 146, an offers map 148, a bubble indicator feature 150, a zoom feature 152, a location selector feature 154, and a filter feature 156, among other features, components and functionalities.

Loyalty Page: In the arrangement shown, as one example, graphical user interface 12 includes a loyalty page 160 (also known as “rewards page”). Loyalty page 160 is formed of any suitable size, shape, and design and is configured to provide viewable information related to the various types of loyalty rewards a user has earned. In the arrangement shown, as one example, a user may have earned any one of a plurality of loyalties and the loyalty page 160 provides a viewable platform of these loyalty rewards.

Additionally, and in the arrangement shown as one example, the loyalty page 160 provides for other loyalty functionality, including but not limited to, accessing loyalties, viewing percentage of loyalties earned, viewing a loyalty summary, scanning loyalties, redeeming loyalties, sharing loyalties, and the like.

In the arrangement shown, as one example, the loyalty page 160 includes, but is not limited to, a title feature 162, a visits indicator 164, a total loyalty indicator 166, a scan loyalty feature 168, a plurality of loyalties 170, a loyalty merchant distance 172, a loyalty good for feature 174, a loyalty amount indicator 176, a loyalty view feature 178, a loyalty share feature 180, a loyalty redeem feature 182, a loyalty sharing indicator 184, a share loyalty feature 186, a share for time feature 188, a share via message feature 190, a share to new friend link generator feature 192, a share to platform friend feature 194, a search friends feature 196, a share instructions tab 198, a privacy indicator 200, and a generate share code feature 202, among other features, components, and functionalities.

Redeem Page: In the arrangement shown, as one example, graphical user interface 12 includes a redeem page 210 (also known as “redeem loyalty page” or “burn page”). Redeem page 210 is formed of any suitable size, shape, and design and is configured to provide a means for a user to redeem loyalty rewards and/or offers. Additionally, and in the arrangement shown as one example, the redeem page 210 is configured to allow a user to pay from a table, view their loyalties at the particular merchant, and perform a number of interactions directly with the restaurant and/or staff without actually seeing or talking to the staff. Additionally, and in the arrangement shown, as one example, the redeem page 210 is configured to tell staff your table number and request to pay, and additionally pay a bill and/or invoice, among other features, components, and functionality.

In the arrangement shown, as one example, the redeem page 210 includes, but is not limited to, a title 212, a location feature 214, a loyalty amount indicator 216, a staff request tab 218, an elapsed time feature 220, a status indicator 222, a table number feature 224, a table number selector 226, a confirm code tab 228, an instructions feature 230, a pay request feature 232, a cancel pay request feature 234, and a rewards available tab 236, among other features, components, and functionalities.

Friends Page: In the arrangement shown, as one example, graphical user interface 12 includes a friends page 240 (also known as “friends of foosh page” or “referrals page”). Friends page 240 is formed of any suitable size, shape, and design and is configured to provide the platform 10 with networking and sharing functionality. In the arrangement shown, as one example, the friends page 240 provides an all in one place for a plurality of functionalities associated with networking. In other words, the friends page 240 is configured to provide a list of friends of a user, loyalties owned by friends, leaderboard functionalities, sort functionalities and more.

In the arrangement shown, as one example, the friends page 240 includes a title 242, an add friend feature 244, a sharing filter feature 246, a referred filter feature 248, a plurality of friends 250, a friend name feature 252, a friend venue counter feature 254, a friend loyalty available feature 256, a friend selector feature 258, and an individual friend page 260, among other features, components, and functionality.

In the arrangement shown, as one example, friends page 240 includes an individual friend page 260 (or a more information feature). Individual friends page 260 is formed of any suitable size, shape, and design and includes, but is not limited to, a title 262, a more information feature 264, a plurality of merchants feature 266, an image indicator 268, a name identifier 270, a last visit indicator 272, a distance feature 274, a total discount available feature 276, a plurality of discount cards 278, and a ratings provided feature 280, among other features, components, and functionality.

Activity Feed Page: In the arrangement shown, as one example, graphical user interface 12 includes an activity feed page 290 (also known as “activity page” or simply “feed”). Activity page 290 is formed of any suitable size, shape, and design and is configured to provide a live feed which provides updated information related but not limited to loyalties earned, offers made, visits to merchants by friends, sharings, ratings, other news, and the like.

In the arrangement shown, as one example, the activity page 290 includes, but is not limited to, a plurality of activities 292, an image indicator 294, a location name 296, a time indicator 298, and an activity notice feature 300, among other features, components, and functionalities.

Profile Page: In the arrangement shown, as one example, graphical user interface 12 includes a profile page 310 (also known as “account page”). Profile page 310 is formed of any suitable size, shape, and design and is configured to provide for changing settings, reviewing information, reviewing information about the platform, registering others, registering merchants, and the like associated with a user's profile.

In the arrangement shown, as one example, profile page 310 includes, but is not limited to, a profile picture 312, a profile name 314, a plurality of settings 316, a switch to business mode feature 318, a manage notifications feature 320, an upcoming bookings feature 322, a profile information feature 324, a privacy and terms feature 326, an open platform settings feature 328, a frequently asked questions section 330, a vote for businesses feature 332, an add business feature 334, and a debug feature 336, among other features, components, and functionalities.

Booking Page: In the arrangement shown, as one example, graphical user interface 12 includes a booking page 340 (also known as “book table page” or simply “book page”). Booking page 340 is formed of any suitable size, shape, and design and is configured to provide a means for a user to book a table, book a meeting, book a consultation, book a product, book a service, and the like.

In the arrangement shown, as one example, booking page 340 includes, but is not limited to, a title 342, a quantity selection feature 344, a time selection feature 346, a book now feature 348, a table booked page feature 350, a title feature 352, a time feature 354, a change time feature 356, a location feature 358, a time indicator 360, an image feature 362, a name feature 364, a loyalty available indicator 366, a deal name 368, a map feature 370, a cancel feature 372, a distance feature 374, an arrived indicator 376, an arrived tab 378, and a welcome page 380, among other features, components, and functionality.

In the arrangement shown, as one example, the booking page 340 includes a welcome page 380. Welcome page 380 is formed of any suitable size, shape, and design and includes, but is not limited to, a title feature 382, a voucher code 384, an instructions feature 386, an order summary 388, a redeem later feature 390, a request bill feature 392 and a cancel booking feature 394, among other features, components, and functionality.

Merchant Page: In the arrangement shown, as one example, graphical user interface 12 includes a merchant page 400 (also known as “business page” or “entity page”). Merchant page 400 is formed of any suitable size, shape, and design and is configured to serve as the main information page related to a merchant. In this way, the merchant page provides a number of readily available details including, but not limited to quick access to ordering, menus, merchant information, merchant appearance, a quick call feature, loyalties available to a user at any given merchant. Additionally, and in the arrangement shown, as one example, a user may have quick access to sharing and redeeming features from the merchant page 400.

In the arrangement shown, as one example, merchant page 400 includes, but is not limited to, an image feature 402, a name tab 404, a distance indicator 406, an identifier 408, a more information link 410, a covid compliance check in feature 412, a get ordering feature 414, a call for service feature 416, a merchant loyalty rewards feature 418, a loyalty amount feature 420, a share loyalty feature 422, and a redeem loyalty feature 424, among other features, components, and functionality.

Referral Page: In the arrangement shown, as one example, graphical user interface 12 includes a referral page 500 (also known as “sharing page” or “sign up page” or “rewards scanning page”). Referral page 500 is formed of any suitable size, shape, and design and is configured to provide an easy referral system and access to easily refer user and/or merchants in just a few moments of time. The referral system and referral page 500 includes various features including discounts earned as a result of referrals and the like.

In the arrangement shown, as one example, referral page 500 includes, but is not limited to, a generate invite feature 502, a generate loyalty feature 504, a scan generator 506, a provide loyalty feature 508, a share loyalty feature 510, a share loyalty generator link 512, an access link 514, an application download link 516, an application download link 518, an email feature 520, a password 522, a create account feature 524, a share loyalty feature 526, a request loyalty feature 528, and an automatic loyalty generation feature 530 for use by a referred friend, among other features, components, and functionality.

Application Server:

In the arrangement shown, as one example, system 10 comprises remote servers 620, databases 14, and/or computers 640 that fulfill the functions disclosed and described herein. In the embodiment depicted, system 10 comprises an application server 600. Application server 600 comprises one or more computer systems adapted to transmit and receive data regarding selected datasets related to various users and/or datasets related to multiple users. Application server 600 is adapted to a query database with unique identification codes to retrieve project information and/or parameters related to users, projects, items, subcontractors, cost codes, inspectors, hours, and more.

Application server 600 may transmit user data related to layers and rules with respect to a single user and/or multiple users. Application server 600 is also adapted to query a user database 14. This query includes receiving and sending user identification codes and user data. Additionally, the application server 600 may communicate with a mobile application, which is adapted to present the user information in a form conducive to being viewed on a mobile device and/or handheld device.

As one of ordinary skill in the art may understand, application server 600, project database, and other databases mentioned herein may be implemented in one or more servers. Furthermore, each may be on multiple servers to increase system efficiency, especially when handling large data gathering, data organizing, such as handling global positioning of a user, following extended rules for various functionality of system 10 and/or processing, updating user information, including various quantities entered.

Additionally, multiple servers may have mirrored data to prevent data loss in case of disk failure and/or to decrease access and response times for database queries. In alternative embodiments, application server 600, and other database procedures may be carried out on computer-readable instructions and data stored on the customer's mobile computing device.

Additionally, system 10 may include a remote server 620, a computing system 640, includes an application programming interface 700 (“API”) which includes tools and resources enabling a user to operate the embodiments herein, and a cloud computing system 720.

Computing System 640:

In one arrangement, as is shown, smart device and/or system 10 includes computing system 640. Computing system 640 is formed of any suitable size, shape, and design and configured to handle computing operations, as are necessary for the operation of the computing functionality of system 10. Computing system 640 is connected with electronic network and/or database and/or server or cloud via communication means and includes a processor, a memory, a microcontroller, a printed circuit board, a microprocessor, a receiver/transceiver, may include at least one antenna, among other components.

Computing device 640 may be formed of any computing device capable of displaying and manipulating data in the manners described herein. Computing device 640 may include for example a desktop computer, a laptop computer, a tablet, smart phone, or any other computing device or other interactive device.

Computing device 640 may be a single consolidated component, or alternatively, computing device 640 may be formed of a plurality of interconnected components that may be co-located or located at different geographic locations. Computing device 640 may be cloud based or it may be hardware based, or cloud capable. In addition, the connected components of computing device 640, including processor, memory, software and interactive user display, may be co-located with computing device 640 or located at different geographic locations. That is, computing device 640 may be made of any form of a device or system that individually or collectively performs the computing operations of system 10.

Printed Circuit Board: In the arrangement shown, as one example, system 10 includes a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to microprocessor. A receiver/transceiver is connected to microprocessor. A receiver is used if one way communication is utilized, whereas a transceiver is used if two-way communication is utilized (hereinafter “transceiver”).

Memory: In the arrangement shown, as one example, system 10 includes a memory. Memory may be formed of any suitable size, shape and design and is configured to facilitate selective storage and retrieval of data (including data) in association with computing device 640, processor, software and interactive user display. Memory may be a single component, such as a single chip or drive or other memory device, or alternatively memory may be formed of a plurality of memory or storage components that are connected to one another that may be co-located or located at different geographic locations.

Alternative Embodiment (Whole Gift Redemption):

In another example of operation and functionality, in addition to the features disclosed herein, the present disclosure provides for merchants the ability to offer loyalty rewards, which have been earned, in exchange for products and/or service offerings. This offering may be given in an alternative to a discount. In one example, and in this arrangement, a merchant can offer a free coffee, a free shirt, a free massage, or any other offering as an alternative to a discount. This offering for rewards earned, may similarly be revealed and/or redeemed in a similar manner to those above. Furthermore, and similar to the other features disclosed herein, rewards and/or loyalties earned for entire gifts and/or products and/or services can be shared with other users and the like.

Alternative Embodiment (Shared Loyalty):

In another example of operation and functionality, in addition to the features disclosed herein, the present disclosure provides for users to share loyalty rewards with friends. As an alternative to gifting loyalty rewards to friends, sharing loyalty rewards with friends gives a user the ability to maintain access to the loyalty. In this way, both the sharer and the user to which the loyalty has been shared with will have access to the loyalty reward and/or discount until one of the users has utilized the loyalty reward. In this way, the sharer still has access to the loyalty even after the loyalty has been shared. In the alternative, gifting means the sharer will no longer have access to the loyalty.

Similarly, and in an alternative embodiment, the sharer of a loyalty may also share a portion of the loyalty and maintain access to the portion of the loyalty as well as the portion of the loyalty which has not been shared. In this way, a sharer of a loyalty portion can give access to part of a loyalty to another user.

Alternative Embodiment (Sign On Bonus):

In another example of operation and functionality, in addition to the features disclosed herein, the present disclosure provides for users, merchant employees, merchants, and others to earn extra sign-on bonuses. Sign on bonuses may be earned in various ways. These include the first installation of the application. This may also include the first engagement with a merchant. This may also share employees earning bonuses for signing up others. This may also include bonuses earned when shared users first engage a merchant, and other combinations of sharing and engaging, signing on, and the like.

Alternative Embodiment (Audience Control):

In another example of operation and functionality, in addition to the features disclosed herein, the present disclosure provides for merchants and the like to enable various audience control features. In this way, merchants can control which groups and/or users may be eligible for certain loyalties and or discounts. Similarly, merchants and/or other users can control if existing promotional codes, promotions or the like can be utilized by certain groups and/or users. Similarly, merchants and/or other users can control if existing promotional codes, promotions or the like can be utilized in concert with loyalties, and by what users, and the like.

Alternative Embodiment (Pay Feature):

In another example of operation and functionality, in addition to the features disclosed herein, the present disclosure provides for the ability to pay merchants and/or other users directly through the loyalty system. This also allows invoicing and/or receipts and payment of those invoices. Similarly, this allows for payment by card, credit card, other payment features such as payment through smart phones and the like. In this way, and additionally, payment through the system can replace the need to scan or the like in order to earn rewards. Payment through the system can also work as a replacement and cause rewards to be earned automatically through a system card.

Similarly, and in an alternative embodiment, a user may add a balance to a system card which can be used for payment and transactions, and the like.

Alternative Embodiment (Gamification/Wager Feature):

In another example of operation and functionality, in addition to the features disclosed herein, the present disclosure provides for gamification of these features and system. Said another way, the present disclosure provides for a wager feature. In this way, the present disclosure provides a feature which allows a user to place an earned discount up for grabs in a risk for earning a larger discount and/or at a risk for losing the discount. In this way, and as one example, a user may wager a percent discount at an opportunity to double or triple the earned discount, as one example. In this way, various odds of winning can be incorporated into the system and merchants can offer additional fun features for users, and the like. Furthermore, games may be incorporated as a means of representing the features such as a roulette board, card games, or other visual engagement features. In one example, a user may have a 5% discount earned. A user may wish to “wager” that discount. In this example a user might double the discount to 10% or forfeit the discount. Other options may be available such as a requirement to wager the whole discount earned at a merchant, or enabling a user to wager partial discounts. In one arrangement, a user may be able to see the odds of winning. In this way, fun and engaging features can be incorporated which are visually appealing to a user.

Alternative Embodiment (Integration):

In another example of operation and functionality, in addition to the features disclosed herein, the present disclosure provides for ecommerce transacting and integration of these features and systems. Said another way, the present disclosure provides for ecommerce customers and/or user transactions for both merchants and customers. Said another way, the present disclosure provides for ecommerce integrations with online shopping, online ordering, and various online platforms. Furthermore, the present disclosure provides for ecommerce integration of various ecommerce platforms. In this way, the present disclosure provides the enhanced benefits and functionalities of the present disclosure in association with various online platforms, redeeming rewards, loyalties, and more.

Alternative Embodiment (Anonymous Interaction):

In another example of operation and functionality, in addition to the features disclosed herein, the present disclosure provides for anonymous ecommerce customer interactions with the platform and/or anonymous engagement of these features and system. Said another way, the present disclosure provides for the ability for a user and/or merchant to engage with the platform and/or interact with the platform without requiring an account to be created and/or a unique identifier. In this way, a user can earn and/or redeem loyalties with a merchant without having an account.

Furthermore, in this way, a user and/or merchant no longer needs to create an account. Said another way, the present disclosure provides a platform set up in which a user and/or merchant can engage with the features herein directly on the web platform, through the application system, through other interface systems directly. In this way, every new user and/or merchant can start with an anonymous account based on the device and/or smart device identification number. This still allows for accumulation of loyalties, tracking and other features as disclosed herein (as linked to the device identification). Furthermore, this feature provides for additional protection of rewards and privacy and the like. In this arrangement, users are further incentivized to join and further hassle free in sign up and use of the platform. This anonymity allows for transacting without revealing personal information, redeeming loyalties and the like herein, while also allowing merchants to understand a user associated with an identification.

In Operation:

As one example, and in the arrangement shown, as one example, system 10 is designed to provide a loyalty sharing system. These operations of the system and various methods of use are hereby contemplated for use and/or disclosed herein.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A loyalty rewards system, comprising:
a graphical interface;
the graphical interface having a landing page;
the graphical interface having an offers page;
the graphical interface having a loyalty page;
the graphical interface having a redeem loyalty page;
the graphical interface having a friends page;
the graphical interface having an activity feed page;
the graphical interface having a profile page;
the graphical interface having a book table feature;
the graphical interface having a welcome page;
the graphical interface having a merchant page;
the graphical interface having a referral feature;
a plurality of merchants;
each of the plurality of merchants having a merchant account;
wherein each of the merchants offers goods or services;
a plurality of users;
each of the plurality of users having a loyalty account;
a loyalty system;
the loyalty system having loyalties;
wherein the loyalty system is configured to allow each of the plurality of users to share loyalties;
wherein the loyalty system is configured to allow each of the plurality of users to redeem loyalties;
wherein the loyalty system is configured to allow each of the plurality of users to redeem a portion of the loyalties;
wherein the loyalty system is configured to allow each of the plurality of users to redeem entire loyalties;
wherein the loyalty system is configured to allow each of the plurality of users to share loyalties with additional users, while maintaining access to and ability to redeem loyalties until the loyalties are redeemed;
a loyalty tracking system;
wherein the loyalty system is configured to provide for the creation of loyalties by each of the plurality of merchants;
wherein the loyalty system is configured to provide for the tracking of loyalties created by each of the plurality of merchants;
wherein the loyalty system is configured to provide tracking of loyalties earned by each of the plurality of users;
wherein the loyalty system is configured to offer loyalties to the plurality of users;
wherein the loyalty tracking system is configured to track loyalties accumulated by each of the plurality of users;
wherein the loyalty tracking system is configured to track loyalties redeemed by each of the plurality of users;
a merchant offer system;
a network platform;
a redemption system;
an application server;
a remote server;
the remote server having a plurality of processors;
the remote server having a plurality of storage mediums;
the remote server having a plurality of databases;
the remote server processing transactions;
the remote server updating loyalty balances for each of the plurality of users;
an application programming interface;
wherein the application programming interface displays information related to the system to each of the plurality of users.

2. The system of claim 1, further comprising:
a plurality of database systems for the storage of data and disbursement of data for the loyalty system;
a plurality of identification elements for identifying and authenticating the plurality of users;
a plurality of identification elements for identifying and authenticating the plurality of merchants.

3. The system of claim 1, further comprising:
a display device;
wherein the display device displays a quick read code associated with a loyalty;
a scanning device;
wherein the scanning device can be used to redeem the loyalty;
wherein the scanning device can be used to share the loyalty.

4. The system of claim 1, further comprising:
at least one processor;
a storage device operably associated with a processor;
a transaction handler;
the transaction handler configured to add loyalties to a user account when the user account of each of the plurality of users earns a loyalty reward;
the transaction handler configured to deduct loyalties from the user account when the user account of each of the plurality of users spends the loyalty reward;
wherein the at least one processor is configured to handle the processing of the loyalty transactions;
wherein the storage device is configured to store data related to balances of loyalties of each of the plurality of users;
wherein the storage device is configured to store data related to balances of loyalties of each of the plurality of merchants.

5. The system of claim 1, further comprising:
an identification feature;
the identification feature having identification information for a plurality of merchants;
the identification feature having identification information for a plurality of users.

6. The system of claim 1, further comprising:
the loyalty system having a payment system;
wherein the payment system is configured to receive payment information for secure transactions;
wherein the payment system is configured to provide payment for goods or services;
wherein the payment system is configured to provide redemption of rewards;
wherein the payment system is part of a computer apparatus;
the computer apparatus having a transaction handler;
wherein the transaction handler authorizes transactions via a processor;
wherein the transactions are payments from an account of a user of the plurality of users to a merchant of the plurality of merchants.

7. The system of claim 1, further comprising:
wherein the plurality of loyalties are redeemed by the plurality of users at the plurality of merchants in exchange for goods or services.

8. The system of claim 1, further comprising:
wherein the plurality of loyalties are redeemed by the plurality of users at the plurality of merchants in exchange for a discount on goods or services.

9. The system of claim 1, further comprising:
an incentivise system;
the incentivise system having a plurality of incentives for the plurality of merchants;
the incentivise system having a plurality of incentives for the plurality of users;
wherein the incentivise system offers the plurality of incentives to encourage the plurality of merchants to sign up for the loyalty system;
wherein the incentivise system offers the plurality of incentives to encourage the plurality of users to sign up for the loyalty system;
wherein the incentivise system offers the plurality of incentives to each of the plurality of users to encourage each of the plurality of users to sign up additional users.

10. The system of claim 1, further comprising:
a smart device;
wherein the smart device is a mobile phone.

11. The system of claim 1, further comprising:
a smart device;
wherein the smart device is a personal computer.

12. The system of claim 1, further comprising:
a geographical location of each of the plurality of users;
a geographical location of each of the plurality of merchants;
a global positioning system;
a smart device;
the smart device having global positioning system location information;
wherein the smart device indicates to each of the plurality of users a list of nearby merchants;
the nearby merchants being merchants with accounts;
wherein the smart device indicates to each of the plurality of users a distance and direction to each of the plurality of merchants.

13. The system of claim 1, further comprising:
a cloud computing system.

14. The system of claim 1, further comprising:
wherein the book table feature is configured to provide for booking a table with a number of patrons attending the table to be booked;
the book table feature having a booking merchant;
wherein the booking merchant is one of the plurality of merchants ready to host the plurality of users;
wherein the book table feature is configured to provide a notification feature;
wherein the notification feature allows for each of the plurality of users to notify the booking merchant of arrival;
wherein the notification feature allows for each of the plurality of users to notify the booking merchant of cancellation;
wherein the notification feature allow for each of the plurality of users to notify the booking merchant of covid protocol criteria;
wherein the notification feature allows for each of the plurality of users to upload images of covid vaccination records.

15. A loyalty reward program which enables users to share loyalty rewards, comprising:
a graphical interface;
a plurality of merchants;
each of the plurality of merchants having a merchant account;
wherein each of the merchants offers goods or services;
a plurality of users;
each of the plurality of users having a loyalty account;
a loyalty system;
the loyalty system having loyalties;
wherein the loyalty system is configured to allow each of the plurality of users to share loyalties;
wherein the loyalty system is configured to allow each of the plurality of users to redeem loyalties;
wherein the loyalty system is configured to allow each of the plurality of users to redeem a portion of the loyalties;
wherein the loyalty system is configured to allow each of the plurality of users to redeem entire loyalties;
wherein the loyalty system is configured to allow each of the plurality of users to share loyalties with additional users, while maintaining access to and ability to redeem loyalties until the loyalties are redeemed;
a loyalty tracking system;
wherein the loyalty system is configured to provide for the creation of loyalties by each of the plurality of merchants;
wherein the loyalty system is configured to provide for the tracking of loyalties created by each of the plurality of merchants;
wherein the loyalty system is configured to provide tracking of loyalties earned by each of the plurality of users;
wherein the loyalty system is configured to offer loyalties to the plurality of users;
wherein the loyalty tracking system is configured to track loyalties accumulated by each of the plurality of users;
wherein the loyalty tracking system is configured to track loyalties redeemed by each of the plurality of users.

16. The system of claim 15, further comprising:
wherein loyalties are generated based on a user of the plurality of users regularly visiting a merchant of the plurality of merchants.

17. The system of claim 15, further comprising:
a merchant offer system;
a network platform;
a redemption system;
an application server.

18. The system of claim 15, further comprising:
a remote server;
the remote server having a plurality of processors;
the remote server having a plurality of storage mediums;
the remote server having a plurality of databases;
the remote server processing transactions;
the remote server updating loyalty balances for each of the plurality of users. an application programming interface;
wherein the application programming interface displays information related to the system to each of the plurality of users.

19. The system of claim 15, further comprising:
wherein the loyalty tracking system can generate loyalties by a predetermined set of rules and provide generated loyalties to a plurality of users based on a predetermined set of rules.

20. A computer implemented method for providing a loyalty system, the method comprising:
providing a mobile application;
the mobile application having a loyalty system;
the loyalty system having a loyalty program;
installing the mobile application onto a smart device;
the smart device having a processor and computer readable storage;
the smart device having an internet connection;
creating a user account;
the user account allowing the user to access the mobile application and mobile application features;
attending a merchant;
the merchant participating in the loyalty program;
purchasing goods or services from the merchant;
earning loyalty rewards from the mobile application;
the loyalty rewards being a discount or a good or a service;
wherein the discount is a portion off of the purchase of future goods or services;
sharing the loyalty reward with a plurality of subsequent users;
redeeming the loyalty reward;
wherein the user and the plurality of subsequent users have access to redeem the loyalty reward until the loyalty reward expires;
wherein the user and the plurality of subsequent users have access to redeem the loyalty reward until the loyalty reward is completely redeemed;
wherein completely redeemed means that the entirety of the loyalty reward earned is redeemed;
wherein redeemed means visiting the merchant on a subsequent visit and applying a portion of the loyalty reward or all of the loyalty reward earned on a previous visit toward a purchase.
